(19) United States
(12) Patent Application Publication
(10) Pub. No.: US 2011/0133412 A1
(43) Pub. Date: Jun. 9, 2011

(54) SEAL ARRANGEMENT

(75) Inventors: Elmar MAUSE, EMSKIRCHEN (DE); Gerald LOESLEIN, ERLANGEN (DE); Akira MATSUNO, HERZOGENAURACH (DE)

(73) Assignee: SCHAEFFLER TECHNOLOGIES GMBH & CO. KG, Herzogenaurach (DE)

(21) Appl. No.: 12/963,101

(22) Filed: Dec. 8, 2010

(30) Foreign Application Priority Data
Dec. 9, 2009 (DE) 10 2009 057 639.8

(51) Int. Cl. F16J 15/32; F16J 15/34

(52) U.S. Cl. 277/352

(57) ABSTRACT

A seal arrangement between two components moving relative to one another. The seal arrangement has a seal which is positioned by way of a seal back in an annular groove of a fixed rolling bearing ring. The seal has at least two elastic sealing lips, a first, radial scaling lip supported by a spring means and a second, axial sealing lip, which are each supported by at least one sealing edge directly or indirectly against a rotating centrifugal sleeve. An intermediate space defined by the sealing edges of the sealing lips is designed as lubricant reservoir. Alternatively or in addition, at least one sealing edge forms a lubricant reservoir in the area of a contact zone of the sealing edge against a support face of the centrifugal sleeve or offset in relation thereto.

### FIELD OF THE INVENTION

The present invention relates to a seal arrangement between two components moving relative to one another. For this purpose a seal comprising at least two elastic sealing lips is positioned by way of a seal back in a groove of a fixed rolling bearing ring. A first radial sealing lip supported by a spring means and a second axial sealing lip are each supported by at least one sealing edge directly or indirectly against a rotating machine part.

### BACKGROUND OF THE INVENTION

Such a seal arrangement is disclosed by DE 38 43 337 A1, among others. In the fitted position the axial sealing lip of this known seal is supported against the contact face of a centrifugal sleeve. The relatively short length of the axial sealing lip in conjunction with the large axial overlap between the axial lip and the contact face leads to an increased contact force, associated with an inadmissibly high degree of overheating. Heavy wear then occurs, particularly at high rotational speeds of the component, due to serious heating, which has an adverse effect on the ability of the seal to function.

Particularly in the case of seals fitted in rolling bearings which are used in a coolant pump of internal combustion engines, a sealing quality is demanded which is sufficient for permanently preventing any penetration of water, water vapor or similar media such as coolant. For protection against the ingress of fluids in liquid or gaseous form, rolling bearing seals for water pumps require both the radial lip and the axial lip of the seal to be in permanent sealing contact with the counter faces throughout the entire service life of the rolling bearing.

### SUMMARY OF THE INVENTION

The object of the invention is to improve the service life of the sealing lips and thereby of the seal.

To achieve this object, an inventive seal concept is proposed in which an intermediate space delimited by the sealing lips and filled with a lubricant forms a lubricant reservoir. An alternative or complementary approach is for one or both of the sealing lips to have a lubricant reservoir in the area of a contact zone, contact face or support face of the sealing edge against the machine part or offset towards the intermediate space in relation thereto. In the operating state of the rolling bearing the lubricant reservoir of the seal according to the invention produces an adequate supply of lubricant to the sealing edge areas. In particular, the lubricant reservoir, which might also be referred to as a grease pocket, in the area of the sealing edge contact zone always ensures a requisite lubricant film between the support area of the sealing lip sealing edge and prevents dry running and an inadmissible temperature increase of the sealing lip. The wear resistance of the sealing lip and consequently the functioning and service life of the seal are thereby decisively improved.

Further advantageous developments of the invention form the subject matter of the dependent claims 2 to 14.

One concrete design development provides for the lubricant reservoir to be formed as a pocket-like recess. Such concave lubricant reservoirs are preferably made in the sealing edge of the sealing lip distributed locally around the circumference.

An alternative approach is to provide a bead in the area of the sealing edge contact zone in order to create a lubricant reservoir. This measure produces a linear contact of the sealing lip and at the same time forms an annular gap between the sealing edge and the contact zone, which in the operating state is filled with lubricant.

To enhance the effectiveness of the invention the sealing edges of all sealing lips of the seal preferably comprise lubricant reservoirs.

The seal according to the invention can advantageously be used in different fitting situations. For example at least one sealing lip of the seal may be supported against a centrifugal sleeve or centrifugal disk, which is rigidly connected to the rotating machine part, in particular a shaft. In the fitted state the seal according to the invention is advantageously assigned to a centrifugal sleeve and together these effectively seal a circular area between an outer rolling bearing ring and a shaft. In this case the centrifugal sleeve is immovably and rotationally fixed to the rotating shaft and forms the contact face for the axial sealing lip and/or the radial sealing lip of the seal. At the same time the circumferential surface of the cylindrical portion of the centrifugal sleeve enclosing the shaft forms a contact face for the radial sealing lip, and the radial rim of the centrifugal sleeve forms the contact face for the axial sealing lip of the shaft lip seal according to the invention.

In a further preferred development a sealing lip comprises two sealing edges, at least one of which encloses a lubricant reservoir. A sealing lip comprising multiple sealing edges produces a graduated, optimized sealing. One approach to this is to design the respective sealing lip so that the sealing edges are supported against one another with different forces. This measure allows the sealing edge designed with the lesser support force to assume the function of a preliminary seal, which prevents the ingress of contaminants or larger particles into the ensuing sealing zone defined by the sealing edge and the contact face, and thereby improves the sealing quality.

One way of forming the lubricant reservoir is to provide the contact zone of the sealing edge or the end face thereof with a textured, geometric structure of waffeled design. The waffeling is preferably introduced locally like a circular arc into the contact face or alternatively it is arranged protruding from the contact face. The thereby reduced contact area occurring between the sealing edge and the corresponding face on the machine part advantageously reduces the heat introduced into the sealing lip. The textured waffeling forming a lubricant reservoir furthermore promotes the take-up of lubricant. In order to improve the sealing quality the waffeling incorporates a twist, which produces a return of the lubricant. The sealing lip is advantageously provided with an alternating twist, which allows the seal to be fitted without reference to the direction of rotation. An arrow structure, for example, which is oriented in the direction of the axis of symmetry of the seal and which always ensures a return of the lubricant regardless of the direction of rotation, is suited to this purpose.

A defined sealing lip overlap is furthermore provided for the seal according to the invention. In order to obtain an adequate sealing lip overlap, irrespective of the temperature and the rotational speed of the component interacting with the sealing lips of the seal, in a fitted position the sealing edge of at least one sealing lip is supported against the associated support face of the machine part with an overlap “x” of 0.05 to 0.55 mm.

In order to achieve efficient sealing, a seal material having a hardness of ≦75 Shore A, which ensures a desired high elasticity of the sealing lip, is proposed for the seal according to the invention. An elastomer such as HNBR or a fluoro rubber such as FPM or FKW is particularly suitable as material for the seal.

In a further measure serving to increase the service life of the sealing lip its sealing edge has a friction-reducing coating, in particular a PTFE coating, at the end. An alternative or complementary approach is to provide at least the area of the machine part, which forms a contact zone, contact face or support face for the sealing edges of the sealing lip, locally or partially with a friction-reducing coating.

The radial sealing lip of the seal according to the invention is advantageously enclosed externally by a spring means. A tubular spring of optimized volume and weight, the diameter d of which is ≦1.1 mm, is preferably provided as a spring means, so that the spring means does not influence the design of the axial sealing lip. The low spring mass serves to prevent any springing up and thereby a detrimental lifting of the sealing lip from the circumferential surface of the shaft.

The seal according to the invention is preferably suited to the sealing of a rolling bearing, which is used in water pumps of internal combustion engines. In this case the seal is inserted in an annular groove of a fixedly positioned bearing ring. Via a sealing edge a radial sealing lip is supported directly against a rotating shaft or indirectly against a cylindrical portion of a centrifugal sleeve or centrifugal disk fixed on the shaft. The further axial sealing lip is supported against a radially oriented member of the centrifugal sleeve. The intermediate space occurring between the sealing lips and filled with lubricant here forms a first lubricant reservoir. As a supplement to this both of the sealing lips may have a lubricant reservoir in the area of a contact zone of the sealing edge against the machine part or offset towards the intermediate space in relation thereto. In the operating state, the lubricant reservoirs ensure an adequate supply of lubricant to the sealing edge areas of the rolling bearing.

The shaft lip seal according to the invention is preferably suited for the use of rolling bearings which are intended for water pumps of internal combustion engines. Here the function of the seal designed according to the invention is to effectively seal a circular area between an outer rolling bearing ring and the pump shaft. The shaft lip seal fixedly arranged in an annular groove of the bearing ring is supported by the sealing edge of a radial sealing lip against the circumferential surface of the shaft or a cylindrical portion of the centrifugal sleeve arranged on the shaft. The other axially oriented sealing lip of the seal according to the invention is frictionally supported against a radial member of the centrifugal sleeve or a contact face of the shaft.

The drawings representing various exemplary embodiments serve to illustrate the invention.

### BRIEF DESCRIPTION OF THE DRAWINGS

In the drawings:

FIG. 1 shows a seal according to the invention comprising two sealing lips in the fitted state;

FIG. 2 shows the seal according to FIG. 1 in conjunction with a centrifugal disk;

FIG. 3a shows an enlarged representation of a first exemplary embodiment of a sealing lip end area designed according to the invention;

FIG. 3b shows an enlarged representation of a second exemplary embodiment of a sealing lip end area designed according to the invention;

FIG. 4a shows an enlarged representation of a third exemplary embodiment of a sealing lip end area designed according to the invention;

FIG. 4b shows an enlarged representation of a fourth exemplary embodiment of a sealing lip end area designed according to the invention.

### DETAILED DESCRIPTION OF THE DRAWINGS

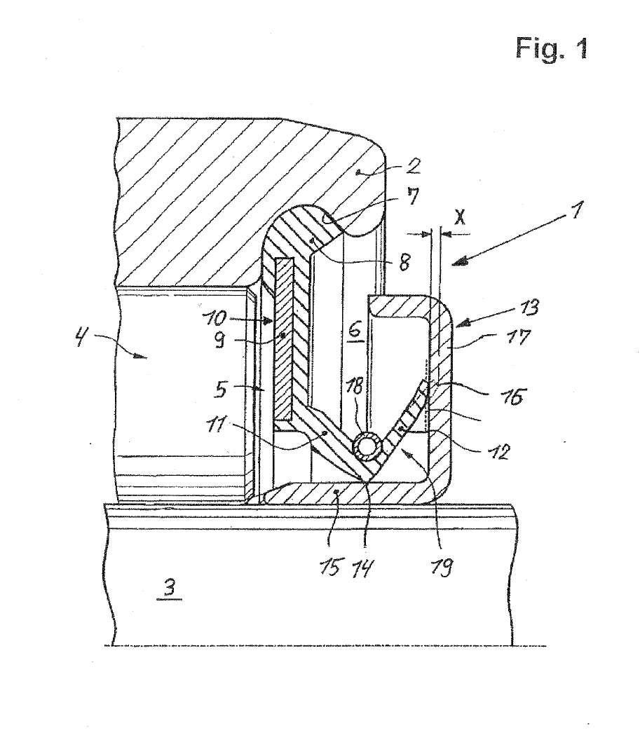

FIG. 1 depicts a seal 1 according to the invention in the fitted state, the seal being intended for the sealing of an annular gap occurring between an outer rolling bearing ring 2 and a rotating shaft 3. The seal 1 assigned to a rolling bearing for a water pump here divides two pressurized spaces, an oil space 5 intended to accommodate rolling bodies 4, and a water space 6, to which the cooling medium, in particular the coolant of an internal combustion engine, is admitted. The seal 1 fixed in an annular groove 7 of the rolling bearing ring 2 by means of an elastic bead 8, a seal back, forms a radial wall 10 oriented towards the shaft and strengthened by a reinforcement 9. The seal 1 forms elastic sealing lips oriented in a V-shape, a first radially oriented sealing lip 11 and a second axially oriented sealing lip 12, which interact with a centrifugal sleeve 13, forming a U-shaped cross sectional profile and fixed to the shaft 3. The radial sealing lip 11 is supported by a sealing edge 14 against a cylindrical portion 15, and the axial sealing lip 12 is supported via a sealing edge 16 against a radial portion 17 of the centrifugal sleeve 13. The sealing lip 12 is supported with an overlap “X” against the radial portion 15. The support force of the sealing lip 11 is reinforced by a spring means 18, in particular a tubular spring or helical spring, externally enclosing the sealing lip 11. These design measures cited above in conjunction with a relatively soft seal material, for example an elastomer such as HNBR of ≦75 Shore A, allows a defined overlap of the sealing lips 11, 12 or their sealing edges 14, 16 in relation to the corresponding contact faces on the centrifugal sleeve 13. In the operating state an intermediate space 19 delimited by the sealing edges 14, 16 of the sealing lips 11, 12 is filled by a lubricant, in particular a lubricant film, and forms a lubricant reservoir.

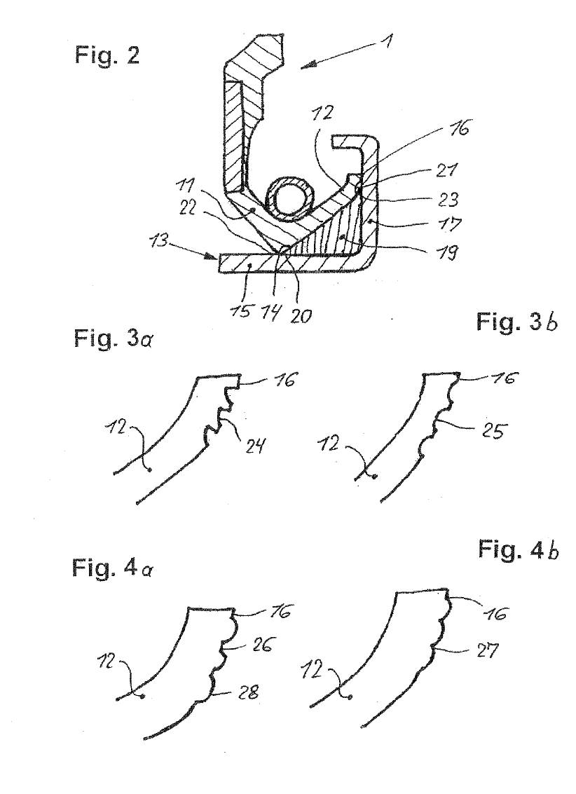

FIG. 2 shows the seal 1 in conjunction with the centrifugal sleeve 13 and in particular illustrates the position and size of the intermediate space 19 forming a lubricant reservoir. Furthermore, in the area of the sealing edges 14, 16 the sealing lips 11, 12 partially form local lubricant reservoirs 20, 21, which serve to ensure a targeted supply of lubricant to the sealing edges 14, 15 in the area of contact zones 22, 23 with the centrifugal sleeve 13. The lubricant reservoirs 20, 21 produce a permanent lubricant film and thereby a low-friction support of the sealing edges 14, 15. A complementary approach is to provide the sealing lips 11, 12 and/or the portions 15, 17 of the centrifugal sleeve 13 in the area of the contact zone 22, 23 with a friction-reducing coating, for example a PTFE coating.

FIGS. 3a to 4b show various lubricant reservoirs according to the invention, arranged at the free end of the sealing lip 12. According to FIG. 3a the sealing edge 16 comprises sawtooth-like recesses, which form lubricant reservoirs 24, which are arranged around part or all of the circumference. The lubricant reservoirs 25 according to FIG. 3a form hemispherical, convex recesses in the sealing edge area of the sealing lip 12. As alternatives to FIGS. 3a and 3b, FIGS. 4a and 4b show sealing edges 16 with a convex profile, an annular gap occurring in relation to the contact zone 23 of the centrifugal sleeve 13. The lubricant reservoirs 26 according to FIG. 4a are formed between staggered, rounded beads 28. FIG. 4b shows lubricant reservoirs 27, which occur between successively aligned beads 29.

### REFERENCE NUMERALS

1 Seal

2 Rolling bearing

3 Shaft

4 Rolling body

5 Oil space

6 Water space

7 Annular groove

8 Bead

9 Reinforcement

10 Wall

11 Sealing lip

12 Sealing lip

13 Centrifugal sleeve

14 Sealing edge

15 Portion

16 Sealing edge

17 Portion

18 Spring means

19 Intermediate space

20 Lubricant reservoir

21 Lubricant reservoir

22 Contact zone

23 Contact zone

24 Lubricant reservoir

25 Lubricant reservoir

26 Lubricant reservoir

27 Lubricant reservoir

28 Bead

29 Bead

1. A seal arrangement between two components moving relative to one another, comprising:
A seal arrangement between two components moving relative to one another, comprising:
a seal positioned by way of a seal back in an annular groove of a fixed rolling hearing ring, the seal comprising at least two elastic sealing lips, a first, radial sealing lip supported by a spring means and a second, axial sealing lip, which are each supported by at least one sealing edge directly or indirectly against a rotating machine part,
wherein an intermediate space delimited by the sealing edges of the sealing lips is designed as a lubricant reservoir and/or at least one sealing edge has a lubricant reservoir directly in the area of a contact zone of the sealing edge against a support face of the machine part or offset in relation thereto.

2. The seal arrangement according to claim 1, wherein, in order to form the lubricant reservoir, the sealing edge of the sealing lip offset towards the intermediate space relative to the contact zone forms a pocket-like recess.

3. The seal arrangement according to claim 1, wherein at least one circumferential bead of the sealing edge forms an annular gap, which is intended as lubricant reservoir, in relation to the contact zone.

4. The seal arrangement according to claim 1, wherein the sealing edges of all sealing lips of the seal each have a lubricant reservoir.

5. The seal arrangement according to claim 1, wherein at least one sealing lip of the seal is supported against a rotating centrifugal sleeve or centrifugal disk, which is rigidly connected to a rotating shaft.

6. The seal arrangement according to claim 1, wherein at least one sealing lip encloses two sealing edges, at least one of which comprises a lubricant reservoir.

7. The seal arrangement according to claim 1, wherein for forming the lubricant reservoir the sealing edge comprises a textured contact zone of waffled design.

8. The seal arrangement according to claim 1, characterized in that in a fitted position the sealing edges of at least one sealing lip are supported against the associated support face of the machine part with an overlap “X” of 0.05 to 0.55 mm.

9. The seal arrangement according to claim 1, wherein the seal material of the seal has a hardness of=75 Shore A.

10. The seal arrangement according to claim 1, wherein an elastomer or a fluoro rubber is provided as material for the seal.

11. The seal arrangement according to claim 1, wherein the sealing edge of the axial sealing lip and/or the radial sealing lip has a friction-reducing coating at the end.

12. The seal arrangement according to at claim 1, wherein the axial sealing lip and/or the radial sealing lip is supported against a support face or contact zone of the centrifugal sleeve provided at least locally or partially with a friction-reducing coating.

13. The seal arrangement according to claim 1, wherein the radial sealing lip is enclosed by a spring means.

14. The seal arrangement according to claim 1, wherein the seal is intended as sealing for a rolling bearing of a water pump, in which the seal inserted in an annular groove with the radial sealing lip is supported via a sealing edge directly or indirectly against a shaft or a cylindrical portion of a centrifugal sleeve, and the sealing edge of the axial sealing lip is supported against a radially oriented member of the centrifugal sleeve.

15. The seal arrangement according to claim 10, wherein the elastomer is HNBR and the fluoro rubber is FPM or FKW.

16. The seal arrangement according to claim 11, wherein the friction-reducing coating is a PTFE coating.
